(19) United States
(12) Patent Application Publication
(10) Pub. No.: US 2025/0218122 A1
(43) Pub. Date: Jul. 3, 2025

(54) THREE-DIMENSIONAL (3D) SEMANTIC RECONSTRUCTION METHOD AND APPARATUS OF LEAF, ELECTRONIC DEVICE, AND STORAGE MEDIUM

(71) Applicants: Information Technology Research Center, Beijing Academy of Agriculture and Forestry Sciences, Beijing (CN); Nongxin Technology (Beijing) Co., Ltd., Beijing (CN)

(72) Inventors: Weiliang WEN, Beijing (CN); Xinyu GUO, Beijing (CN); Shenghao GU, Beijing (CN); Sheng WU, Beijing (CN); Xianju LU, Beijing (CN)

(21) Appl. No.: 19/000,830

(22) Filed: Dec. 24, 2024

(30) Foreign Application Priority Data
Dec. 27, 2023 (CN) 202311820797.5

(51) Int. Cl. G06T 17/20; G06T 7/13

(52) U.S. Cl. CPC G06T 17/205; G06T 7/13; G06T 2207/10028; G06T 2210/12; G06T 2210/36

(57) ABSTRACT

This application relates to the technical field of image processing, and provides a three-dimensional (3D) semantic reconstruction method and apparatus of a leaf, an electronic device, and a storage medium. The 3D semantic reconstruction method of a leaf includes: taking 3D point cloud data of a crop leaf as an input, generating an initial mesh of the crop leaf based on the 3D point cloud data, remeshing the initial mesh, mapping a 3D mesh to a two-dimensional (2D) space by parameterization, determining semantic surface feature points of a 2D mesh, and performing 3D semantic reconstruction based on corresponding points of the semantic surface feature points in the 3D mesh to obtain a 3D semantic mesh model of the crop leaf.

### CROSS REFERENCE TO RELATED APPLICATION

This patent application claims the benefit and priority of Chinese Patent Application No. 2023118207975, filed with the China National Intellectual Property Administration on Dec. 27, 2023, the disclosure of which is incorporated by reference herein in its entirety as part of the present application.

### TECHNICAL FIELD

The present disclosure relates to the technical field of image processing, and in particular to a three-dimensional (3D) semantic reconstruction method and apparatus of a leaf, an electronic device, and a storage medium.

### BACKGROUND

3D reconstruction work of the crops mainly focuses on 3D mesh reconstruction. 3D semantic reconstruction of crop leaves is intended to make vertices or edges of the reconstructed mesh model contain specific semantic information.

According to the existing methods, in order to obtain a 3D mesh model containing semantic information, data containing semantic information is acquired mainly by 3D digitization. In combination with mesh deformation, 3D semantic modeling of the plant leaf can be realized. However, this method has a high workload and low efficiency, with the accuracy greatly affected by manual operations.

### SUMMARY

The present disclosure provides a 3D semantic reconstruction method and apparatus of a leaf, an electronic device, and a storage medium, to improve the reconstruction efficiency of the leaf in 3D semantic reconstruction.

The present disclosure provides a 3D semantic reconstruction method of a leaf, including:
performing surface reconstruction on 3D point cloud data of a crop leaf based on scale-space surface reconstruction to obtain an initial mesh of the crop leaf;
remeshing the initial mesh based on isotropic remeshing to obtain a 3D mesh of the crop leaf;
mapping the 3D mesh to a two-dimensional (2D) space based on as rigid as possible (ARAP) mesh parameterization to obtain a 2D mesh of the crop leaf;
determining edge points of the crop leaf based on a number of neighborhood points to each vertex in the 2D mesh, and performing 2D semantic interpolation on the 2D mesh based on the edge points to obtain semantic surface feature points of the 2D mesh; and
performing, based on corresponding points of the semantic surface feature points in the 3D mesh, 3D semantic reconstruction on the crop leaf to obtain a 3D semantic mesh model of the crop leaf.

According to the 3D semantic reconstruction method of a leaf provided by the present disclosure, the performing, based on corresponding points of the semantic surface feature points in the 3D mesh, 3D semantic reconstruction on the crop leaf to obtain a 3D semantic mesh model of the crop leaf includes:
determining proximal points at shortest Euclidean distances with the semantic surface feature points in the 2D mesh;
determining corresponding points of the proximal points in the 3D mesh; and
connecting the corresponding points to obtain the 3D semantic mesh model of the crop leaf

According to the 3D semantic reconstruction method of a leaf provided by the present disclosure, the connecting the corresponding points to obtain the 3D semantic mesh model of the crop leaf includes:
connecting each row of corresponding points in the 3D mesh to obtain multiple connected rows; and
connecting adjacent rows of corresponding points in the multiple connected rows to form quadrilaterals, and connecting diagonals of the quadrilaterals to obtain the 3D semantic mesh model of the crop leaf.

After the determining edge points of the crop leaf based on a number of neighborhood points to each vertex in the 2D mesh, the 3D semantic reconstruction method of a leaf provided by the present disclosure further includes:
constructing a 2D coordinate system; and
determining oriented bounding box (OBB) information of the edge points, and based on the OBB information, moving the 2D mesh in a plane of the 2D coordinate system, such that a length direction of the 2D mesh is parallel to a Y-axis direction of the 2D coordinate system, and a lowest point of the 2D mesh coincides with an origin of the 2D coordinate system.

According to the 3D semantic reconstruction method of a leaf provided by the present disclosure, the performing 2D semantic interpolation on the 2D mesh based on the edge points to obtain semantic surface feature points of the 2D mesh includes:
transversely dividing the 2D mesh based on the edge points to obtain multiple transverse lines of the 2D mesh; and
equally dividing the multiple transverse lines to determine the semantic surface feature points of the 2D mesh.

After obtaining the initial mesh of the crop leaf, the 3D semantic reconstruction method of a leaf provided by the present disclosure further includes:
repairing the initial mesh based on a triangular mesh hole-filling algorithm to obtain a repaired initial mesh.

Before the performing surface reconstruction on 3D point cloud data of a crop leaf based on scale-space surface reconstruction, the 3D semantic reconstruction method of a leaf provided by the present disclosure further includes:
acquiring the 3D point cloud data of the crop leaf, and performing preprocessing on the 3D point cloud data, the preprocessing including voxel downsampling, outlier removal, and point cloud smoothing.

The present disclosure further provides a 3D semantic reconstruction apparatus of a leaf, including:
a surface reconstruction module configured to perform surface reconstruction on 3D point cloud data of a crop leaf based on scale-space surface reconstruction to obtain an initial mesh of the crop leaf;
a remeshing module configured to remesh the initial mesh based on isotropic remeshing to obtain a 3D mesh of the crop leaf;
a mesh parameterization module configured to map the 3D mesh to a 2D space based on ARAP mesh parameterization to obtain a 2D mesh of the crop leaf;
a semantic surface feature point determination module configured to determine edge points of the crop leaf based on a number of neighborhood points to each vertex in the 2D mesh, and perform 2D semantic interpolation on the 2D mesh based on the edge points to obtain semantic surface feature points of the 2D mesh; and
a 3D semantic reconstruction module configured to perform, based on corresponding points of the semantic surface feature points in the 3D mesh, 3D semantic reconstruction on the crop leaf to obtain a 3D semantic mesh model of the crop leaf.

The present disclosure further provides an electronic device, including a memory, a processor, and a computer program stored in the memory and executable on the processor, where when the computer program is executed by the processor, the 3D semantic reconstruction method of a leaf is implemented.

The present disclosure further provides a non-transitory computer-readable storage medium, storing a computer program, where when the computer program is executed by a processor, the 3D semantic reconstruction method of a leaf is implemented.

According to the 3D semantic reconstruction method and apparatus of a leaf, the electronic device, and the storage medium provided by the present disclosure, by taking 3D point cloud data of a crop leaf as an input, generating an initial mesh of the crop leaf based on the 3D point cloud data, remeshing the initial mesh, mapping a 3D mesh to a 2D space, determining semantic surface feature points of a 2D mesh, and performing 3D semantic reconstruction based on corresponding points of the semantic surface feature points in the 3D mesh, the present disclosure makes the reconstructed 3D semantic mesh model contain semantic information. Without extensive manual operations, the present disclosure automatically reconstructs the 3D semantic mesh model of the crop leaf at high accuracy, and improves the reconstruction efficiency.

### BRIEF DESCRIPTION OF THE DRAWINGS

To describe the technical solutions in the present disclosure or in the prior art more clearly, the following briefly describes the accompanying drawings required for describing the embodiments or the prior art. Apparently, the accompanying drawings in the following description show some embodiments of the present disclosure, and a person of ordinary skill in the art may still derive other accompanying drawings from these accompanying drawings without creative efforts.

FIG. 1 is a schematic flowchart of a 3D semantic reconstruction method of a leaf according to the present disclosure;

FIG. 2 is a partially enlarged view after remeshing according to the present disclosure;

FIG. 3 is a schematic view of semantic surface feature points according to the present disclosure;

FIG. 4 is a schematic view of corresponding points in a 3D mesh according to the present disclosure;

FIG. 5 is a schematic view of a 3D semantic mesh model according to the present disclosure;

FIG. 6 is a schematic structural view of a 3D semantic reconstruction apparatus of a leaf according to the present disclosure; and

FIG. 7 is a structural schematic view of an electronic device according to the present disclosure.

### DETAILED DESCRIPTION OF THE EMBODIMENTS

To make the objectives, technical solutions and advantages of the present disclosure clearer, the following clearly and completely describes the technical solutions in the present disclosure with reference to the accompanying drawings in the present disclosure. Apparently, the described embodiments are some but not all of the embodiments of the present disclosure. All other embodiments obtained by a person of ordinary skill in the art based on the embodiments of the present disclosure without creative efforts shall fall within the protection scope of the present disclosure.

Morphological structures of crops are the most direct way to reflect their life states, and are also the important basis to make decisions for management in crop production. 3D morphological analysis offers a novel tool for scientific research of the crops. Through accurate measurement and modeling on the 3D morphological structures of the crops, the growth and development of the crops are simulated and predicted.

3D reconstruction is a core to understand and extract 3D point cloud data of the crops. It mainly focuses on accurate analysis on sizes and morphologies of organs of the crops, and is intended to solve key problems required by visual representation from the 3D point cloud to the 3D model, and to the final visual computation.

3D reconstruction work of the crops mainly focuses on 3D mesh reconstruction. Related methods for 3D reconstruction of crop leaves include: Level sets are used for boundary optimization to realize the 3D reconstruction of plant leaves. In combination with morphological features of wheat leaves and smooth spline surfaces, the 3D reconstruction of the wheat leaves is realized. The voxel-based 3D reconstruction method Morfit is used to realize the approximate reconstruction for point clouds of the leaves. Through mesh generation and boundary optimization, a smooth surface mesh model is obtained. There are also 3D reconstruction of plant leaves in case of noises and missing point clouds, and 3D reconstruction of plant leaves based on a Voxel Carving method. The above methods mainly realize the 3D reconstruction from the point cloud to the mesh. The reconstructed mesh is poorly structured without semantic information.

3D semantic reconstruction is intended to make vertices or edges of the reconstructed mesh model contain specific semantic information. There is rare work on the 3D semantic reconstruction. According to the related methods, in order to obtain a 3D mesh model containing semantic information, data containing semantic information is acquired mainly by 3D digitization. In combination with mesh deformation, 3D semantic modeling of the plant leaves can be realized. However, this method has a high workload and low efficiency, with the accuracy greatly affected by manual operations. Parametric modeling is typical to research 3D modeling of plants. It involves excessive interactions, and is combined with measured data hardly for high-precision modeling, although the constructed plant leaf contains semantic information. For the Self-Organized Map Lattice in the point cloud-based 3D mesh reconstruction of the plant leaf, the reconstructed mesh model contains the semantic information, but the reconstruction effect is undesirable, and the accuracy is to be improved.

The related methods have the following defects:

For the point cloud-based 3D reconstruction of the crop leaves, the obtained mesh does not contain semantic information, or only contains little semantic information.

The point cloud-based 3D reconstruction of the crop leaves has the low accuracy.

The 3D digitalization for acquiring the mesh data containing the semantic information has the high workload and the low efficiency, with the accuracy greatly affected by manual operations.

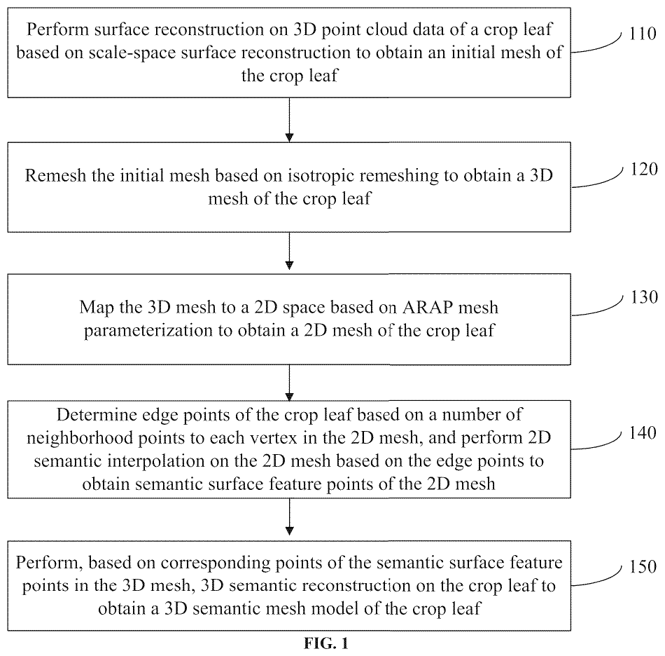

In view of defects of the related methods, the present disclosure provides a 3D semantic reconstruction method of a leaf. FIG. 1 is a schematic flowchart of a 3D semantic reconstruction method of a leaf according to the present disclosure. Referring to FIG. 1, the 3D semantic reconstruction method of a leaf provided by the present disclosure includes:
Step 110: Surface reconstruction is performed on 3D point cloud data of a crop leaf based on scale-space surface reconstruction to obtain an initial mesh of the crop leaf.
Step 120: The initial mesh is remeshed based on isotropic remeshing to obtain a 3D mesh of the crop leaf.
Step 130: The 3D mesh is mapped to a 2D space based on ARAP mesh parameterization to obtain a 2D mesh of the crop leaf.
Step 140: Edge points of the crop leaf are determined based on a number of neighborhood points to each vertex in the 2D mesh, and 2D semantic interpolation is performed on the 2D mesh based on the edge points to obtain semantic surface feature points of the 2D mesh.
Step 150: Based on corresponding points of the semantic surface feature points in the 3D mesh, 3D semantic reconstruction is performed on the crop leaf to obtain a 3D semantic mesh model of the crop leaf.

The 3D semantic reconstruction method of a leaf provided by the present disclosure may be executed by an electronic device, a component in the electronic device, an integrated circuit, or a chip. The electronic device may be a mobile electronic device, and may also be a nonmobile electronic device. Exemplarily, the mobile electronic device may be a cellphone, a tablet computer, a notebook computer, a palm computer, an ultra-mobile personal computer (UMPC), a netbook or a personal digital assistant (PDA), or the like. The nonmobile electronic device may be a server, a network attached storage (NAS) or a personal computer (PC) or the like. Both the mobile electronic device and the nonmobile electronic device are not specifically defined in the present disclosure.

With a computer for executing the 3D semantic reconstruction method of a leaf provided by the present disclosure as an example, the technical solutions of the present disclosure are described below in detail.

In Step 110, surface reconstruction is performed on 3D point cloud data of a crop leaf based on scale-space surface reconstruction to obtain an initial mesh of the crop leaf.

The 3D point cloud data of the crop leaf is acquired. Preprocessing may be performed on acquired 3D point cloud data.

The preprocessing on the point cloud of the leaf includes voxel downsampling, outlier removal, and point cloud smoothing. To improve execution efficiency of subsequent algorithms, all leaves are set as a same voxel size. The input point cloud of the leaf is downsampled by the voxel downsampling. The downsampled point cloud is filtered to remove outliers. To eliminate unsmooth features caused by abnormal data in the point cloud, the Jet Fitting method is used to smooth the filtered point cloud. As an algorithm for surface fitting and reconstruction, the Jet Fitting method is often used to generate a continuous surface model from discrete point cloud data. This method is mainly used to process 3D point cloud data, and fit the 3D point cloud data into a quadric surface.

The surface reconstruction is performed on the 3D point cloud data of the crop leaf based on the scale-space surface reconstruction to obtain the initial mesh of the crop leaf.

The scale-space surface reconstruction is an algorithm used for generating a continuous surface model from the point cloud data. In combination with the scale-space theory and the surface reconstruction, the method can smooth the point cloud at different scales, and gradually restore a more sophisticated surface structure.

The scale-space surface reconstruction captures detailed information on the surface of the data by analyzing the data at different scales. This alleviates problems such as noise and obstruction, and improves the stability of the surface reconstruction.

In Step 120, the initial mesh is remeshed based on isotropic remeshing to obtain a 3D mesh of the crop leaf.

As an algorithm for adjusting the 3D model mesh, the isotropic remeshing makes the newly generated mesh more uniform, regular, and isotropic. The method is often used to optimize the mesh structure, improve the model quality, and simplify the subsequent processing task.

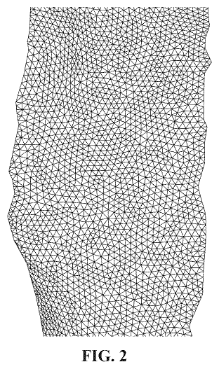

In view of subsequent sampling on the 3D leaf, the initial mesh model is optimized and refined to provide more specific sampling points. Without affecting the morphology of the leaf, this optimizes the mesh structure, and improves the distribution density of the points. Specifically, the initial mesh is remeshed by the isotropic remeshing to obtain the 3D mesh of the crop leaf. The partially enlarged view of the remeshed 3D mesh is as shown in FIG. 2. Meanwhile, the remeshed mesh can be refined by setting an average edge length.

In Step 130, the 3D mesh is mapped to a 2D space based on ARAP mesh parameterization to obtain a 2D mesh of the crop leaf.

Based on the ARAP mesh parameterization, the 3D mesh is parameterized. With the parameterization, the 3D mesh is transformed to the 2D space at a minimal energy loss.

Specifically, the ARAP mesh parameterization is intended to keep the shape of the mesh as rigid as possible, so as to prevent unnatural distortions and extensions. The parameterized 2D mesh and the 3D mesh have a one-to-one mapping relationship in vertices and a same topology, and can be searched to each other based on the mapping relationship.

In Step 140, edge points of the crop leaf are determined based on a number of neighborhood points to each vertex in the 2D mesh, and 2D semantic interpolation is performed on the 2D mesh based on the edge points to obtain semantic surface feature points of the 2D mesh.

It is to be understood that in the parameterized 2D mesh, the edge point involves less neighborhood points, while the internal point involves more neighborhood points.

By determining the number of neighborhood points to each vertex of the mesh, the edge points of the 2D mesh can be obtained. Based on the edge points of the 2D mesh, the edge points of the crop leaf can be determined.

After the edge points of the crop leaf are obtained, the 2D semantic interpolation is performed on the 2D mesh to obtain the semantic surface feature points of the 2D mesh.

In Step 150, based on corresponding points of the semantic surface feature points in the 3D mesh, 3D semantic reconstruction is performed on the crop leaf to obtain a 3D semantic mesh model of the crop leaf.

After multiple semantic surface feature points in the 2D mesh are obtained, corresponding points of the semantic surface feature points in the 3D mesh are determined. Based on the corresponding points in the 3D mesh, the 3D semantic reconstruction is performed on the crop leaf to obtain the 3D semantic mesh model of the crop leaf. This returns semantic information of the leaf in the 2D space to the 3D space.

Optionally, on the basis of the 2D mesh, and the semantic surface feature points, the 3D semantic mesh model is reconstructed. This may specifically include 3D semantic point resampling, generation of a semantic mesh, and post-processing.

3D point resampling: For each semantic surface feature point, a point at a shortest Euclidean distance with the leaf semantic feature point is found in the remeshed 2D mesh. According to the one-to-one correspondence relationship between the 3D mesh and the 2D parameterized mesh in vertices, a spatial point coordinate in the 3D mesh can be localized, thereby completing the resampling of the 3D point. By this time, each 3D point contains semantic information transmitted from the 2D point, and its semantic information can be determined according to a serial number of the 3D sampling point on the leaf.

Generation of the semantic mesh: The 3D semantic mesh model is constructed according to each corresponding 3D point. Each row of adjacent points are connected. Adjacent rows of corresponding points are connected to form quadrilaterals. Diagonals of the quadrilaterals are connected to form triangular facets. All points are output counterclockwise, thereby obtaining the 3D semantic mesh model.

Post-processing: During preprocessing of the leaf, some important feature points at the edge or tip of the leaf may be lost due to operations like point cloud denoising or point cloud smoothing. This leads to large errors in subsequent calculation of such phenotypic parameters as the leaf length and the leaf width. Therefore, the post-processing is performed on the reconstructed 3D semantic mesh model. The reconstructed 3D semantic mesh model is compared with the input 3D point cloud data. The feature points are adjusted in the leaf width direction and the leaf tip direction, such that the reconstructed 3D semantic mesh model can be approximate to the 3D point cloud data more accurately to improve the reconstruction accuracy.

Optionally, after the 3D semantic mesh model is obtained, the reconstructed 3D semantic mesh model containing the semantic information can be used to calculate relevant phenotypes of the leaf, mainly including the leaf length, the leaf width, and the 3D leaf area. The leaf length is mainly a sum of Euclidean distances between adjacent vein points in the 3D semantic mesh model. The leaf width is a maximum among lengths of the rows. The 3D leaf area is a sum of areas of all triangular facets.

According to the 3D semantic reconstruction method of a leaf provided by the embodiment of the present disclosure, by taking 3D point cloud data of a crop leaf as an input, generating an initial mesh of the crop leaf based on the 3D point cloud data, remeshing the initial mesh, mapping a 3D mesh to a 2D space, determining semantic surface feature points of a 2D mesh, and performing 3D semantic reconstruction based on corresponding points of the semantic surface feature points in the 3D mesh, the present disclosure makes the reconstructed 3D semantic mesh model contain semantic information. Without extensive manual operations, the present disclosure automatically reconstructs the 3D semantic mesh model of the crop leaf at high accuracy, and improves the reconstruction efficiency.

In an embodiment, that based on corresponding points of the semantic surface feature points in the 3D mesh, 3D semantic reconstruction is performed on the crop leaf to obtain a 3D semantic mesh model of the crop leaf includes: Proximal points at shortest Euclidean distances with the semantic surface feature points are determined in the 2D mesh. Corresponding points of the proximal points in the 3D mesh are determined. The corresponding points are connected to obtain the 3D semantic mesh model of the crop leaf.

After the semantic surface feature points are obtained, the proximal points at the shortest Euclidean distances with the semantic surface feature points are determined in the 2D mesh. It is to be understood that the semantic surface feature points are feature points obtained through the 2D semantic interpolation on the 2D mesh, rather than actual points in the 2D mesh.

In the 2D mesh, the proximal points at the shortest Euclidean distances with the semantic surface feature points are determined. The determined proximal points and the corresponding semantic surface feature points contain similar semantic information. Each point in the 2D mesh has the corresponding point in the 3D mesh. Hence, the corresponding point of the proximal point in the 3D mesh can be determined, and the determined corresponding point also contains corresponding semantic information.

The corresponding points are connected to obtain the 3D semantic mesh model of the crop leaf containing the semantic information.

According to the 3D semantic reconstruction method of a leaf provided by the embodiment of the present disclosure, after the semantic surface feature points are obtained, proximal points at shortest Euclidean distances with the semantic surface feature points are determined in the 2D mesh. Corresponding points of the proximal points in the 3D mesh are determined. The corresponding points are connected to determine the 3D semantic mesh model of the crop leaf.

In an embodiment, that the corresponding points are connected to obtain the 3D semantic mesh model of the crop leaf includes: Each row of corresponding points in the 3D mesh to obtain multiple connected rows. Adjacent rows of corresponding points in the multiple connected rows are connected to form quadrilaterals. Diagonals of the quadrilaterals are connected to obtain the 3D semantic mesh model of the crop leaf.

After multiple corresponding points in the 3D mesh are obtained, each row of corresponding points in the 3D mesh are determined.

Each row of corresponding points are connected to obtain multiple connected rows. Adjacent rows of corresponding points in the multiple connected rows are connected to form quadrilaterals. Diagonals of the quadrilaterals are connected to form triangular facets, thereby obtaining the 3D semantic mesh model of the crop leaf.

It is to be understood that since each corresponding point for constructing the 3D semantic mesh model contains semantic information, the obtained 3D semantic mesh model also contains corresponding semantic information.

According to the 3D semantic reconstruction method of a leaf provided by the embodiment of the present disclosure, after multiple corresponding points in the 3D mesh are obtained, based on each corresponding point containing semantic information, the 3D semantic mesh model containing semantic information is constructed.

In an embodiment, after that edge points of the crop leaf are determined based on a number of neighborhood points to each vertex in the 2D mesh, the 3D semantic reconstruction method of a leaf provided by the present disclosure further includes: A 2D coordinate system is constructed. OBB information of the edge points is determined, and based on the OBB information, the 2D mesh is moved in a plane of the 2D coordinate system, such that a length direction of the 2D mesh is parallel to a Y-axis direction of the 2D coordinate system, and a lowest point of the 2D mesh coincides with an origin of the 2D coordinate system.

After the 2D mesh is obtained, normalization is performed on the 2D mesh.

The normalization specifically includes:

A 2D coordinate system is constructed.

In the 2D mesh, an OBB for the edge points is calculated, thereby determining OBB information of the edge points. Based on determined OBB information, the leaf is rotated in a plane of the 2D coordinate system, until a length direction is parallel to a Y-axis. A lowest portion of the leaf is translated to an origin of the 2D coordinate system, thereby completing the normalization on the 2D leaf.

According to the 3D semantic reconstruction method of a leaf provided by the embodiment of the present disclosure, after the 2D mesh is obtained, normalization is performed on the 2D mesh. This lays a foundation to subsequently determine the semantic surface feature points.

In an embodiment, that 2D semantic interpolation is performed on the 2D mesh based on the edge points to obtain semantic surface feature points of the 2D mesh includes: The 2D mesh is transversely divided based on the edge points to obtain multiple transverse lines of the 2D mesh. The multiple transverse lines are equally divided to determine the semantic surface feature points of the 2D mesh.

It is to be understood that the determined edge points are edge points of the leaf in the 2D mesh. After the edge points are determined, the 2D mesh is divided in the X direction and the Y direction of the 2D coordinate system to realize the 2D semantic interpolation on the 2D mesh to obtain the semantic surface feature points of the 2D mesh.

Optionally, that the 2D mesh is divided in the X direction and the Y direction of the 2D coordinate system may specifically include:

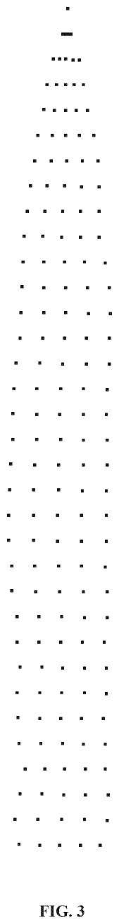

According to a 2D width w_{2D}) (a width of the 2D leaf OBB) of the leaf, assuming that the leaf is divided into n_{w} segments (n_{w}=4, that is, each row includes five sampling points, in which the first sampling point and the fifth sampling point are located at two sides of the leaf, and the third sampling point is considered as a vein point) in the width direction (transverse direction), then the leaf is transversely divided at a stride S_{w}=W_{2D}/n_{w}. In order that the final reconstructed 3D semantic mesh model has uniform triangles, the leaf is divided in the length direction (longitudinal direction) at a stride s₁=s_{w}. According to a 2D length 1_{2D}) (a length of the 2D leaf OBB), the leaf is divided into nₗ=└l_{2D}/Sₗ┘ in the length direction. Sₗ=l_{2D}/nₗ is further updated. The 2D leaf is divided uniformly in the length direction according to the Sₗ. The edge point is an intersection between the transverse division line and the edge of the 2D leaf. Each transverse line is divided uniformly into n_{w} segments, thereby completing the semantic interpolation on the 2D mesh. The division point of the line in the semantic interpolation is the semantic surface feature point. The obtained semantic surface feature points are as shown in FIG. 3.

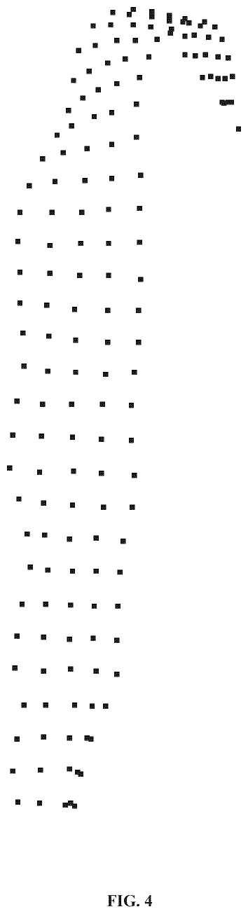

After the semantic surface feature points are obtained, corresponding points of the semantic surface feature points in the 3D mesh are determined. The obtained corresponding points of the semantic surface feature points in the 3D mesh are as shown in FIG. 4.

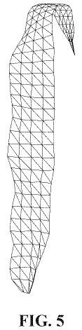

Based on the corresponding points of the semantic surface feature points in the 3D mesh, the 3D semantic reconstruction is performed on the crop leaf to obtain the 3D semantic mesh model of the crop leaf. Specifically, the 3D semantic mesh model is constructed according to each corresponding 3D point. Each row of adjacent points are connected. Adjacent rows of corresponding points are connected to form quadrilaterals. Diagonals of the quadrilaterals are connected to form triangular facets. All points are output counterclockwise, thereby obtaining the 3D semantic mesh model. The obtained 3D semantic mesh model of the crop leaf is as shown in FIG. 5.

According to the 3D semantic reconstruction method of a leaf provided by the embodiment of the present disclosure, after the edge points are determined, the 2D mesh is segmented in the X direction and the Y direction of the 2D coordinate system to realize the 2D semantic interpolation on the 2D mesh to determine the semantic surface feature points.

In an embodiment, after the initial mesh of the crop leaf is obtained, the 3D semantic reconstruction method of a leaf provided by the present disclosure further includes: The initial mesh is repaired based on a triangular mesh hole-filling algorithm to obtain a repaired initial mesh.

Due to data acquisition or intrinsic factors of the leaf, some 3D point cloud data of the crop leaf are missing to cause holes in the initial mesh.

To ensure that subsequent algorithms can be executed, the holes in the initial mesh are repaired, thereby obtaining the initial mesh with a desirable topological structure. The initial mesh is repaired with the triangular mesh hole-filling algorithm. The triangular mesh hole-filling algorithm is intended to repair holes (missing triangles) in a 3D triangular mesh model. In the 3D modeling and the computer graphics, the triangular mesh model is a surface model composed of multiple triangles, and holes are missing triangular regions in the model.

Since the initial mesh is an open mesh, the edge of the leaf is considered as a big hole in the algorithm, and the leaf is directly repaired as a closed mesh. Therefore, to repair the mesh, it is necessary to exclude the biggest hole at the edge.

According to the 3D semantic reconstruction method of a leaf provided by the embodiment of the present disclosure, the initial mesh is repaired through the triangular mesh hole-filling algorithm, thereby improving the accuracy of the initial mesh.

In an embodiment, before the surface reconstruction is performed on 3D point cloud data of the crop leaf based on the scale-space surface reconstruction, the 3D semantic reconstruction method of a leaf provided by the present disclosure further includes: The 3D point cloud data of the crop leaf is acquired, and preprocessing is performed on the 3D point cloud data. The preprocessing includes voxel downsampling, outlier removal, and point cloud smoothing.

The preprocessing on the point cloud of the leaf includes voxel downsampling, outlier removal, and point cloud smoothing. To improve execution efficiency of subsequent algorithms, all leaves are set as a same voxel size. The input point cloud of the leaf is downsampled by the voxel downsampling. The downsampled point cloud is filtered to remove outliers. To eliminate unsmooth features caused by abnormal data in the point cloud, the Jet Fitting method is used to smooth the filtered point cloud. As an algorithm for surface fitting and reconstruction, the Jet Fitting method is often used to generate a continuous surface model from discrete point cloud data. The method is mainly used to process 3D point cloud data, and fit the 3D point cloud data into a quadric surface.

According to the 3D semantic reconstruction method of a leaf provided by the embodiment of the present disclosure, by acquiring the 3D point cloud data of the crop leaf, and performing the preprocessing on the 3D point cloud data, the accuracy of the subsequent 3D semantic reconstruction is improved.

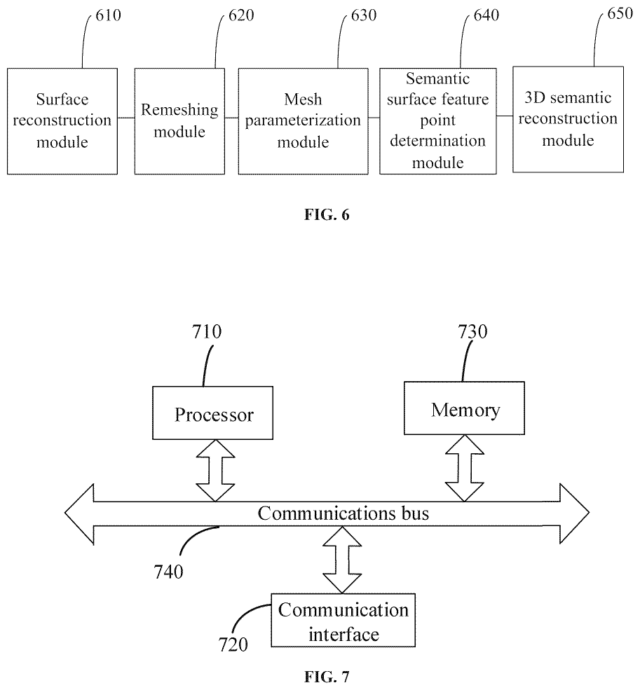

FIG. 6 is a schematic structural view of a 3D semantic reconstruction apparatus of a leaf according to the present disclosure. As shown in FIG. 6, the 3D semantic reconstruction apparatus of a leaf includes: a surface reconstruction module 610, a remeshing module 620, a mesh parameterization module 630, a semantic surface feature point determination module 640, and a 3D semantic reconstruction module 650.

The surface reconstruction module 610 is configured to perform surface reconstruction on 3D point cloud data of a crop leaf based on scale-space surface reconstruction to obtain an initial mesh of the crop leaf.

The remeshing module 620 is configured to remesh the initial mesh based on isotropic remeshing to obtain a 3D mesh of the crop leaf.

The mesh parameterization module 630 is configured to map the 3D mesh to a 2D space based on ARAP mesh parameterization to obtain a 2D mesh of the crop leaf.

The semantic surface feature point determination module 640 is configured to determine edge points of the crop leaf based on a number of neighborhood points to each vertex in the 2D mesh, and perform 2D semantic interpolation on the 2D mesh based on the edge points to obtain semantic surface feature points of the 2D mesh.

The 3D semantic reconstruction module 650 is configured to perform, based on corresponding points of the semantic surface feature points in the 3D mesh, 3D semantic reconstruction on the crop leaf to obtain a 3D semantic mesh model of the crop leaf.

According to the 3D semantic reconstruction apparatus of a leaf provided by the embodiment of the present disclosure, by taking 3D point cloud data of a crop leaf as an input, generating an initial mesh of the crop leaf based on the 3D point cloud data, remeshing the initial mesh, mapping a 3D mesh to a 2D space, determining semantic surface feature points of a 2D mesh, and performing 3D semantic reconstruction based on corresponding points of the semantic surface feature points in the 3D mesh, the present disclosure makes the reconstructed 3D semantic mesh model contain semantic information. Without extensive manual operations, the present disclosure automatically reconstructs the 3D semantic mesh model of the crop leaf at high accuracy, and improves the reconstruction efficiency.

In an embodiment, the 3D semantic reconstruction module 650 is specifically configured to implement the following operation:

Based on corresponding points of the semantic surface feature points in the 3D mesh, 3D semantic reconstruction is performed on the crop leaf to obtain a 3D semantic mesh model of the crop leaf, including:

Proximal points at shortest Euclidean distances with the semantic surface feature points are determined in the 2D mesh.

Corresponding points of the proximal points in the 3D mesh are determined.

The corresponding points are connected to obtain the 3D semantic mesh model of the crop leaf.

In an embodiment, the 3D semantic reconstruction module 650 is further specifically configured to implement the following operation:

The corresponding points are connected to obtain the 3D semantic mesh model of the crop leaf, including:

Each row of corresponding points are connected in the 3D mesh to obtain multiple connected rows.

Adjacent rows of corresponding points in the multiple connected rows are connected to form quadrilaterals, and diagonals of the quadrilaterals are connected to obtain the 3D semantic mesh model of the crop leaf.

In an embodiment, the semantic surface feature point determination module 640 is specifically configured to implement the following operation:

After the edge points of the crop leaf are determined based on the number of neighborhood points to each vertex in the 2D mesh, the following operation is further included:

A 2D coordinate system is constructed.

OBB information of the edge points is determined, and based on the OBB information, the 2D mesh is moved in a plane of the 2D coordinate system, such that a length direction of the 2D mesh is parallel to a Y-axis direction of the 2D coordinate system, and a lowest point of the 2D mesh coincides with an origin of the 2D coordinate system.

In an embodiment, the semantic surface feature point determination module 640 is further specifically configured to implement the following operation:

2D semantic interpolation is performed on the 2D mesh based on the edge points to obtain semantic surface feature points of the 2D mesh, including:

The 2D mesh is transversely divided based on the edge points to obtain multiple transverse lines of the 2D mesh.

The multiple transverse lines are equally divided to determine the semantic surface feature points of the 2D mesh.

In an embodiment, the surface reconstruction module 610 is specifically configured to implement the following operation:

After the initial mesh of the crop leaf is obtained, the following operation is further included:

The initial mesh is repaired based on a triangular mesh hole-filling algorithm to obtain a repaired initial mesh.

In an embodiment, the surface reconstruction module 610 is further specifically configured to implement the following operation:

Before surface reconstruction is performed on 3D point cloud data of the crop leaf based on scale-space surface reconstruction, the following operation is further included:

The 3D point cloud data of the crop leaf is acquired, and preprocessing is performed on the 3D point cloud data, the preprocessing including voxel downsampling, outlier removal, and point cloud smoothing.

FIG. 7 is a schematic structural view of an electronic device. As shown in FIG. 7, the electronic device may include a processor 710, a communications interface 720, a memory 730, and a communications bus 740. The processor 710, the communications interface 720, and the memory 730 communicate with one another by means of the communications bus 740. The processor 710 may be configured to invoke a logic instruction in the memory 730 to execute the 3D semantic reconstruction method of a leaf. The 3D semantic reconstruction method of a leaf includes:

Surface reconstruction is performed on 3D point cloud data of a crop leaf based on scale-space surface reconstruction to obtain an initial mesh of the crop leaf.

The initial mesh is remeshed based on isotropic remeshing to obtain a 3D mesh of the crop leaf.

The 3D mesh is mapped to a 2D space based on ARAP mesh parameterization to obtain a 2D mesh of the crop leaf.

Edge points of the crop leaf are determined based on a number of neighborhood points to each vertex in the 2D mesh, and 2D semantic interpolation is performed on the 2D mesh based on the edge points to obtain semantic surface feature points of the 2D mesh.

Based on corresponding points of the semantic surface feature points in the 3D mesh, 3D semantic reconstruction is performed on the crop leaf to obtain a 3D semantic mesh model of the crop leaf.

Besides, the logic instruction in the memory 730 may be implemented as a software function unit and be stored in a computer-readable storage medium when sold or used as a separate product. On the basis of such understanding, the technical solutions of the present disclosure essentially or the part contributing to the prior art or the part of the technical solutions may be embodied in a form of a software product. The computer software product is stored in a storage medium, and includes several instructions for enabling a computer device (which may be a personal computer, a server, a network device, etc.) to execute all or some steps of the methods described in the embodiments of the present disclosure. The foregoing storage medium includes various media capable of storing a program code, such as a USB flash disk, a mobile hard disk, a read-only memory (ROM), a random access memory (RAM), a magnetic disk, or an optical disc.

In another aspect, the present disclosure further provides a computer program product. The computer program product includes a computer program stored in a non-transitory computer-readable storage medium. The computer program includes a program instruction. When the program instruction is executed by a processor, a computer may execute the 3D semantic reconstruction method of a leaf, which includes the following steps:

Surface reconstruction is performed on 3D point cloud data of a crop leaf based on scale-space surface reconstruction to obtain an initial mesh of the crop leaf.

The initial mesh is remeshed based on isotropic remeshing to obtain a 3D mesh of the crop leaf.

The 3D mesh is mapped to a 2D space based on ARAP mesh parameterization to obtain a 2D mesh of the crop leaf.

Edge points of the crop leaf are determined based on a number of neighborhood points to each vertex in the 2D mesh, and 2D semantic interpolation is performed on the 2D mesh based on the edge points to obtain semantic surface feature points of the 2D mesh.

Based on corresponding points of the semantic surface feature points in the 3D mesh, 3D semantic reconstruction is performed on the crop leaf to obtain a 3D semantic mesh model of the crop leaf.

In yet another aspect, the present disclosure further provides a non-transitory computer-readable storage medium. The non-transitory computer-readable storage medium stores a computer program. When the computer program is executed by a processor, the 3D semantic reconstruction method of a leaf is implemented, which includes the following steps:

Surface reconstruction is performed on 3D point cloud data of a crop leaf based on scale-space surface reconstruction to obtain an initial mesh of the crop leaf.

The initial mesh is remeshed based on isotropic remeshing to obtain a 3D mesh of the crop leaf.

The 3D mesh is mapped to a 2D space based on ARAP mesh parameterization to obtain a 2D mesh of the crop leaf.

Edge points of the crop leaf are determined based on a number of neighborhood points to each vertex in the 2D mesh, and 2D semantic interpolation is performed on the 2D mesh based on the edge points to obtain semantic surface feature points of the 2D mesh.

Based on corresponding points of the semantic surface feature points in the 3D mesh, 3D semantic reconstruction is performed on the crop leaf to obtain a 3D semantic mesh model of the crop leaf.

The apparatus embodiment described above is merely schematic, where the unit described as a separate component may or may not be physically separated, and a component displayed as a unit may or may not be a physical unit, that is, the component may be located at one place, or distributed on multiple network units. Some or all of the modules may be selected based on actual needs to achieve the objectives of the solutions of the embodiments. A person of ordinary skill in the art can understand and implement the embodiments without creative efforts.

Through the description of the foregoing implementations, a person skilled in the art can clearly understand that the implementations can be implemented by means of software plus a necessary universal hardware platform, or certainly, can be implemented by hardware. Based on such understanding, the foregoing technical solution which is essential or a part contributing to the prior art may be embodied in the form of a software product, the computer software product may be stored in a computer readable storage medium, such as an ROM/RAM, a magnetic disk or an optical disc, including a plurality of instructions for causing a computer device (which may be a personal computer, a server, or a network device) to perform the methods described in the examples or some parts of the examples.

Finally, it should be noted that the above examples are only intended to illustrate, but not to limit, the technical solutions of the present disclosure; although the present disclosure has been described in detail with reference to the foregoing examples, those of ordinary skill in the art should understand that: the technical solutions recorded in the foregoing examples may be still modified, or some of the technical features may be equivalently substituted; these modifications or substitutions do not cause the essence of the corresponding technical solutions to depart from the spirit and scope of the technical solutions of the examples of the present disclosure.

What is claimed is:

1. A three-dimensional (3D) semantic reconstruction method of a leaf, comprising:
performing surface reconstruction on 3D point cloud data of a crop leaf based on scale-space surface reconstruction to obtain an initial mesh of the crop leaf;
remeshing the initial mesh based on isotropic remeshing to obtain a 3D mesh of the crop leaf;
mapping the 3D mesh to a two-dimensional (2D) space based on as rigid as possible (ARAP) mesh parameterization to obtain a 2D mesh of the crop leaf;
determining edge points of the crop leaf based on a number of neighborhood points to each vertex in the 2D mesh, and performing 2D semantic interpolation on the 2D mesh based on the edge points to obtain semantic surface feature points of the 2D mesh; and
performing, based on corresponding points of the semantic surface feature points in the 3D mesh, 3D semantic reconstruction on the crop leaf to obtain a 3D semantic mesh model of the crop leaf.

2. The 3D semantic reconstruction method of a leaf according to claim 1, wherein the performing, based on corresponding points of the semantic surface feature points in the 3D mesh, 3D semantic reconstruction on the crop leaf to obtain a 3D semantic mesh model of the crop leaf comprises:
determining proximal points at shortest Euclidean distances with the semantic surface feature points in the 2D mesh;
determining corresponding points of the proximal points in the 3D mesh;
connecting the corresponding points to obtain the 3D semantic mesh model of the crop leaf.

3. The 3D semantic reconstruction method of a leaf according to claim 2, wherein the connecting the corresponding points to obtain the 3D semantic mesh model of the crop leaf comprises:
connecting each row of corresponding points in the 3D mesh to obtain multiple connected rows; and
connecting adjacent rows of corresponding points in the multiple connected rows to form quadrilaterals, and connecting diagonals of the quadrilaterals to obtain the 3D semantic mesh model of the crop leaf.

4. The 3D semantic reconstruction method of a leaf according to claim 1, after the determining edge points of the crop leaf based on a number of neighborhood points to each vertex in the 2D mesh, further comprising:
constructing a 2D coordinate system; and
determining oriented bounding box (OBB) information of the edge points, and based on the OBB information, moving the 2D mesh in a plane of the 2D coordinate system, such that a length direction of the 2D mesh is parallel to a Y-axis direction of the 2D coordinate system, and a lowest point of the 2D mesh coincides with an origin of the 2D coordinate system.

5. The 3D semantic reconstruction method of a leaf according to claim 4, wherein the performing 2D semantic interpolation on the 2D mesh based on the edge points to obtain semantic surface feature points of the 2D mesh comprises:
transversely dividing the 2D mesh based on the edge points to obtain multiple transverse lines of the 2D mesh; and
equally dividing the multiple transverse lines to determine the semantic surface feature points of the 2D mesh.

6. The 3D semantic reconstruction method of a leaf according to claim 1, after obtaining the initial mesh of the crop leaf, further comprising:
repairing the initial mesh based on a triangular mesh hole-filling algorithm to obtain a repaired initial mesh of the crop leaf.

7. The 3D semantic reconstruction method of a leaf according to claim 1, before the performing surface reconstruction on 3D point cloud data of a crop leaf based on scale-space surface reconstruction, further comprising:
acquiring the 3D point cloud data of the crop leaf, and performing preprocessing on the 3D point cloud data, the preprocessing comprising voxel downsampling, outlier removal, and point cloud smoothing.

8. A three-dimensional (3D) semantic reconstruction apparatus of a leaf, comprising:
a surface reconstruction module configured to perform surface reconstruction on 3D point cloud data of a crop leaf based on scale-space surface reconstruction to obtain an initial mesh of the crop leaf;
a remeshing module configured to remesh the initial mesh based on isotropic remeshing to obtain a 3D mesh of the crop leaf;
a mesh parameterization module configured to map the 3D mesh to a two-dimensional (2D) space based on as rigid as possible (ARAP) mesh parameterization to obtain a 2D mesh of the crop leaf;
a semantic surface feature point determination module configured to determine edge points of the crop leaf based on a number of neighborhood points to each vertex in the 2D mesh, and perform 2D semantic interpolation on the 2D mesh based on the edge points to obtain semantic surface feature points of the 2D mesh; and
a 3D semantic reconstruction module configured to perform, based on corresponding points of the semantic surface feature points in the 3D mesh, 3D semantic reconstruction on the crop leaf to obtain a 3D semantic mesh model of the crop leaf.

9. An electronic device, comprising a memory, a processor, and a computer program stored in the memory and executable on the processor, wherein when the computer program is executed by the processor, the three-dimensional (3D) semantic reconstruction method of a leaf according to claim 1 is implemented.

10. A non-transitory computer-readable storage medium, storing a computer program, wherein when the computer program is executed by a processor, the three-dimensional (3D) semantic reconstruction method of a leaf according to claim 1 is implemented.

11. The electronic device according to claim 9, wherein the performing, based on corresponding points of the semantic surface feature points in the 3D mesh, 3D semantic reconstruction on the crop leaf to obtain a 3D semantic mesh model of the crop leaf comprises:
determining proximal points at shortest Euclidean distances with the semantic surface feature points in the 2D mesh;
determining corresponding points of the proximal points in the 3D mesh;
connecting the corresponding points to obtain the 3D semantic mesh model of the crop leaf.

12. The electronic device according to claim 11, wherein the connecting the corresponding points to obtain the 3D semantic mesh model of the crop leaf comprises:
connecting each row of corresponding points in the 3D mesh to obtain multiple connected rows; and
connecting adjacent rows of corresponding points in the multiple connected rows to form quadrilaterals, and connecting diagonals of the quadrilaterals to obtain the 3D semantic mesh model of the crop leaf.

13. The electronic device according to claim 9, after the determining edge points of the crop leaf based on a number of neighborhood points to each vertex in the 2D mesh, further comprising:
constructing a 2D coordinate system; and
determining oriented bounding box (OBB) information of the edge points, and based on the OBB information, moving the 2D mesh in a plane of the 2D coordinate system, such that a length direction of the 2D mesh is parallel to a Y-axis direction of the 2D coordinate system, and a lowest point of the 2D mesh coincides with an origin of the 2D coordinate system.

14. The electronic device according to claim 13, wherein the performing 2D semantic interpolation on the 2D mesh based on the edge points to obtain semantic surface feature points of the 2D mesh comprises:
transversely dividing the 2D mesh based on the edge points to obtain multiple transverse lines of the 2D mesh; and
equally dividing the multiple transverse lines to determine the semantic surface feature points of the 2D mesh.

15. The electronic device according to claim 9, after obtaining the initial mesh of the crop leaf, further comprising:
repairing the initial mesh based on a triangular mesh hole-filling algorithm to obtain a repaired initial mesh of the crop leaf.

16. The electronic device according to claim 9, before the performing surface reconstruction on 3D point cloud data of a crop leaf based on scale-space surface reconstruction, further comprising:
acquiring the 3D point cloud data of the crop leaf, and performing preprocessing on the 3D point cloud data, the preprocessing comprising voxel downsampling, outlier removal, and point cloud smoothing.

17. The non-transitory computer-readable storage medium according to claim 10, wherein the performing, based on corresponding points of the semantic surface feature points in the 3D mesh, 3D semantic reconstruction on the crop leaf to obtain a 3D semantic mesh model of the crop leaf comprises:
determining proximal points at shortest Euclidean distances with the semantic surface feature points in the 2D mesh;
determining corresponding points of the proximal points in the 3D mesh;
connecting the corresponding points to obtain the 3D semantic mesh model of the crop leaf.

18. The non-transitory computer-readable storage medium according to claim 17, wherein the connecting the corresponding points to obtain the 3D semantic mesh model of the crop leaf comprises:
connecting each row of corresponding points in the 3D mesh to obtain multiple connected rows; and
connecting adjacent rows of corresponding points in the multiple connected rows to form quadrilaterals, and connecting diagonals of the quadrilaterals to obtain the 3D semantic mesh model of the crop leaf.

19. The non-transitory computer-readable storage medium according to claim 10, after the determining edge points of the crop leaf based on a number of neighborhood points to each vertex in the 2D mesh, further comprising:
constructing a 2D coordinate system; and
determining oriented bounding box (OBB) information of the edge points, and based on the OBB information, moving the 2D mesh in a plane of the 2D coordinate system, such that a length direction of the 2D mesh is parallel to a Y-axis direction of the 2D coordinate system, and a lowest point of the 2D mesh coincides with an origin of the 2D coordinate system.

20. The non-transitory computer-readable storage medium according to claim 19, wherein the performing 2D semantic interpolation on the 2D mesh based on the edge points to obtain semantic surface feature points of the 2D mesh comprises:
transversely dividing the 2D mesh based on the edge points to obtain multiple transverse lines of the 2D mesh; and
equally dividing the multiple transverse lines to determine the semantic surface feature points of the 2D mesh.
